(19) United States
(12) Patent Application Publication
(10) Pub. No.: US 2007/0257106 A1
(43) Pub. Date: Nov. 8, 2007

(54) SYSTEM AND METHOD FOR PERFORMING CHARITABLE GIFT CARD/CERTIFICATE DONATIONS

(76) Inventor: Michelle SARKANY, Fresh Meadows, NY (US)

Correspondence Address: GOTTLIEB RACKMAN & REISMAN PC, 270 MADISON AVENUE, 8TH FLOOR, NEW YORK, NY, 10016-0601, US

(21) Appl. No.: 11/744,381

(22) Filed: May 4, 2007

Related U.S. Application Data
(60) Provisional application No. 60/797,623, filed on May 5, 2006.

(51) Int. Cl. G06K 5/00; G06Q 40/00

(52) U.S. Cl. 235/380; 705/37

(57) ABSTRACT

The invention relates to a new method and system for enabling charitable donation giving through the donation of a gift card or gift certificate issued by any number of businesses and donated through a donor of the gift card/certificate. The system collects the gift card, converts the gift card into funds and then distributes at least part of the funds thus generated to at least one charity. The system also issues a receipt to the donor indicating how much was obtained for the donated card, and, optionally, how much of the collected funds were given directly to a designated charity. The funds are obtained by selling the donated gift cards.

### RELATED APPLICATIONS

This application claims priority to provisional application Ser. No. 60/797,623 filed May 5, 2006 and incorporated herein by reference.

### BACKGROUND OF THE INVENTION

1. Field of the Invention

The invention relates generally to the field of charitable giving, and more particularly to a method and system for a party to enable a gift card or gift certificate to be used as a charitable donation.

2. Description of the Prior Art

Charitable giving has long been lauded as a desirable social objective. Prior art charitable giving systems have typically included two parties—the donor, and the donee charity, with the donation being made with cash, check or credit cards. This approach remains the primary model in which charitable giving occurs, but new methods of facilitating charitable giving are desirable.

The ability to convey any assets other than cash, check, or credit card to make a charitable donation to another party has heretofore been nonexistent, or at the least cumbersome. A common prior art system enables an individual or organization to make a charitable donation to a specific donee charity with liquid assets. This prior art system suffers, however, from the inability of the individual or organization making the donation from using any other form of monetary payment.

It has therefore become desirable to develop a new method and system for enabling charitable donations through the use of a pre-issued gift card or gift certificate, as accomplished by the present invention.

### SUMMARY OF THE INVENTION

The invention relates to a new method and system for enabling charitable donation giving through the donation of a gift card or gift certificate issued by any number of businesses and donated through a recipient of the gift card/certificate. A server operates a web site, and potentially other support services, such as telephonic support. A donor visits the host web site and selects a charity to which he would like to donate his gift card/gift certificate, which has been issued to him by an outside establishment. The gift card/certificate donor may also give the option of where to donate the gift card/certificate to the host web site. The donor fills out a form stating which charity they would like to donate to or if he has no preference and would like the charity to be chosen for him by the server, along with his contact information, face value of the card or certificate to be donated, expiration date, and other similar information. This form is then either mailed by the gift card/certificate donor with the gift card/certificate being donated to a collection site where the server then sells the gift card/certificate or retrieves the monetary value by other means and donates the money received for the card/certificate, minus service charges, to the chosen charity. Or the form is submitted through the server website sending the information automatically through the server website to an outside site allowing the gift card/certificate to be immediately listed for sale, sold, and then the monetary value retrieved automatically sent to the charity chosen to receive the donation by the gift card/certificate donor, minus services charges. A letter of acknowledgement of the donation may or may not be sent to the donor by the server or by the charity. Charity issued gift card may also be offered by charity for direct purchase by donor, the value of which would be for the purpose of donation to that charity, with the card providing proof for donor of donation for tax purposes.

### BRIEF DESCRIPTION OF THE DRAWINGS

The present invention is illustrated by way of example and not limitation in the accompanying figures, in which like references indicate similar elements, and in which:

FIG. 1 is a diagram showing a base computer system and network for carrying out a preferred embodiment of the present invention; and

FIGS. 2A and 2B are flowcharts showing a preferred embodiment of the methodology of multi-party charitable gift giving of the present invention.

### DESCRIPTION OF THE PREFERRED EMBODIMENT

The following discussion is intended to provide a detailed description of at least one embodiment of the invention and should not be taken to be limiting of the invention itself. Rather, any number of variations may fall within the scope of the invention.

The system and method of the present invention contemplates the involvement of several parties. It provides a mechanism and infrastructure for a party (such as a charity) to receive liquid assets or funds generated by the sale of a donated instrument such as a gift card or gift certificate.

Generally, in a preferred embodiment of the invention, a typical system 10 may incorporate several different elements integrated systems as follows:

a public web site 12 accessible from via the Internet or other similar distributed computer network;

a standard internet portal 14 provided by an ISP;

a master server 16 that monitors and controls the operation of the system as herein described;

several collecting stations 20, 22 that receive donated cards; and

a card resale member or service 24.

These elements and their mode of operation are described in greater detail below.

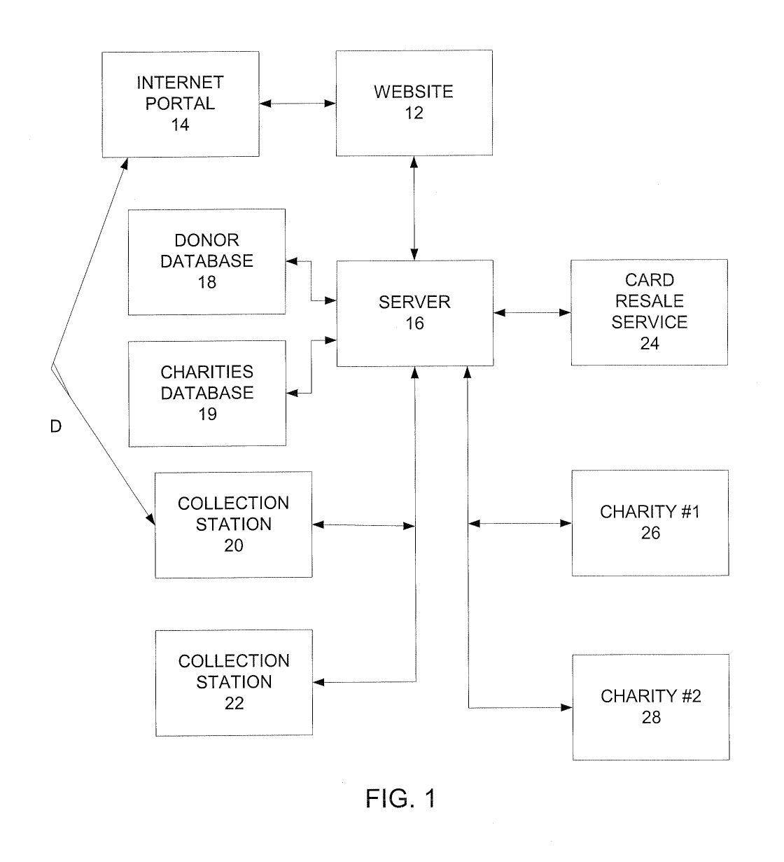

First, to initialize the process a donor D signs up on web site 12 through a standard ISP 14. The web site 12 is the primary interface between the host and its respective groups. Referring to FIG. 1, the web site 12 communicates with a server 16, which is in communication with donor data base 18 for storing gift donor information and a charities data base 19 for storing information regarding various charitable organizations.

The web site 12 allows the gift card/certificate donor D and other customers to search for and learn about various charities, to fill out a form for donating gift card/certificate, and obtain donation information. The web site 12 also serves as the mechanism for charities to update their information in charities data base 19, track charitable gift information, and serve as a payment processing mechanism for donations made to their organization. Visitors may also search the charities data base 19 and view detailed information about charities that have provided information to server 12.

Preferably, when a donor decides to donate to a charity, he fills out a Gift Card/Certificate Donation Form on website 12. This form serves as a tool for gathering information on the gift card/certificate being donated, the donor, and the charity to receive the donation. The form includes the name, address, and other personal information regarding the donor, as well as information on the gift card such as its value, expiration date, and issuer, and the name of the charity to receive the donation or whether said charity should be chosen at random by the host.

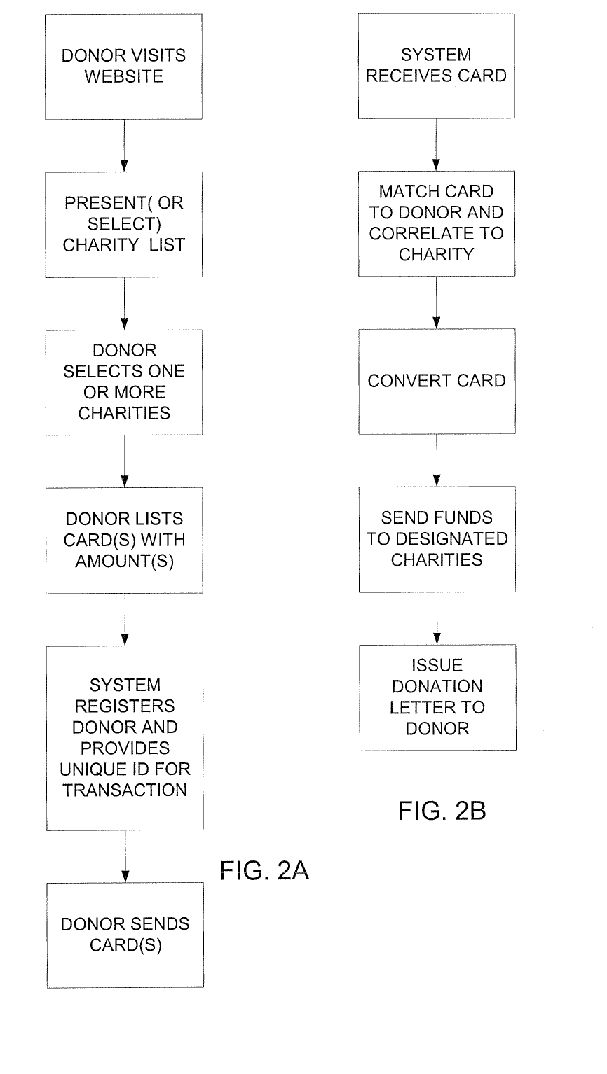

The server 16 acts as a Customer Service System, and performs all necessary operations including call center operations, that allow an agent to handle customer service issues and perform maintenance on the web site. The Customer Service System is used primarily by customer service representatives handling phone and email correspondence with customers (including gift card/certificate donors), charities, and the general public. The Customer Service System is also used to update the content on the site, check the value of gift cards/certificates being donated, sell the gift cards/certificates being donated, using for, instance a card resale service 24, send tax receipts to the donor, and perform other database functionality. A typical process for performing these steps is summarized by the flow chart of FIG. 2A.

Sale of Gift Card/Certificate to an Outside Buyer

The sale of Gift Card/Certificate to an outside buyer can be done upon receipt of the gift card/certificate from the donor along with the donation mail in form. The value of the gift card/certificate is checked and once validated, is sold for the highest receivable value. It can be sold a number of ways to any number of outside buyers.

Outside Issuer of Gift Card/Certificate, Either a Merchant or Service Provider

The Outside Issuer of Gift Card/Certificate, Either a Merchant or Service Provider has issued the gift card/certificate being donated to the donor or to another party who has given the gift card/certificate to the donor. The gift card/certificate issuer has no part in the donation process other than being the establishment at which the gift card/certificate was created and given value. This merchant or service provider acknowledges the gift card/certificate's value and they allow the gift card/certificate to be redeemed for goods or services. A great number of merchants and service providers issue gift cards/certificates. The merchants and service providers from which a gift card/certificate will be accepted for donation depend on a variety of factors including popularity, recognition, and its ability to sell easily at face or close to face value.

The Acknowledgment of Donation Sent to Donor

The Acknowledgment of Donation Sent to donor is a letter stating the value of the donation. It can also state which charity received the donation. This acknowledgment of donation letter acknowledges the donation to a 501c3 qualified non-profit charity which the card/certificate donor can use to determine whether or not their donation makes them eligible for a charitable tax deduction.

Charity Payment Process

The Charity Payment Process involves the distribution of funds to charities selected by a gift card/certificate donor or by the host once permission to do so is granted by gift card/certificate donor. The charity is selected, either by the gift card/certificate donor or by the host once permission to do so is granted by gift card/certificate donor. The process concludes when the funds are received and accounted for by the charity.

A process for handling one or more donated gift cards is summarized by the flow chart of FIG. 2B.

In alternative embodiments, the gift card/certificate donor may provide additional information. For example, the gift card/certificate donor D may designate a group or predefined category of charities from which the gift recipient may choose, or designate specific charities or categories thereof which may not be selected by the gift recipient (e.g., if the gift giver is opposed to abortion rights, he or she may select the Planned Parenthood organization as a charity that the gift recipient may not select).

Once the charity is chosen or the choice is given to the host, the gift card/certificate donor fills out a short online mail in form including their personal information and information on the card they wish to donate. Information can include, but is not limited to their name, address, email and phone number as well as the issuing establishment of the gift card/certificate being donated, its expiration date, and monetary value.

The mail in form is then mailed, and may also be emailed, with aforementioned information as well as the physical gift card/certificate. The mail in form and gift card/certificate are sent through the mail, email, or any other means. The form and the card are collected at a one or more collection stations 20, 22. Upon receipt the gift card/certificate is checked for authenticity. The gift card/certificate is then sold to an outside party who wishes to buy the card or the monetary value is taken directly from the card by electronic means if possible. If sold, it is sold for as close to the monetary value of the card as possible. In a preferred embodiment, a tax receipt is sent to the gift card/certificate donor so that the gift card/certificate donor may potentially obtain a tax benefit.

In one embodiment, the server 16 keeps confidential the names of gift recipients and donors associated with each donation, unless provided express permission to release such information to the chosen charities.

The charity is transmitted the value of the charity donation received from the sale of the gift card/certificate. This value may be aggregated with other donors contribution to the charity.

To summarize, as shown in FIG. 2A, a donor visits website 12 and is presented with a list of charities. The donor selects one or more charities. Alternatively, the site can obtain information from a donor on what kind of charities the donor likes, and the site 12 then suggests one or more appropriate charities. In yet another embodiment, the site 12 picks and assigns one or more charities randomly. The donor also indicates the card(s) that he wants to donate, including the issuer of the card, the face value, expiration date, and so on. Preferably, the donation is registered and given an ID number that identifies the transaction. Once the system receives all the information, the donor form is printed out and is used by the donor to mail in his gift card. The form identifies one of the collection stations 20, 22 as the recipient.

Once a card is received, it can be handled manually by a person. Alternatively, its processing may be completely automated. In the following discussion an automated operation is described in FIG. 2B. The system 10 receives the card together with the form. The form includes the unique ID of the transaction. This ID is either entered manually into the system at the collection station, or can be scanned or otherwise recognized. For example, the form issued to the donor may include a bar code with the transaction ID. Thus, at the collection station the card is inserted into an appropriate card reader (not shown) and the card information is provided to the server together with the transaction ID. The server 16 matches the received form and the card with its donor. Next, the server 16 converts the card into liquid assets, e.g. by selling the card through the card resale service or by other means. This service may sell various cards individually or in bulk to interested individuals. Alternatively, the service can sell the cards to other entities, including the entity that issued the card. Preferably, the service 24 sells cards in a manner that insures a maximum return. Alternatively, the system can be automated directly from the moment the donor form is submitted. The information would be sent directly to one or more sites where gift cards/certificates can be sold allowing the gift card/certificate to be listed automatically while the individual's personal information is received by the system. The gift card/certificate can then be sent directly to the gift card purchaser or system 10, which would either mail it on to the purchaser or remove the monetary value directly through electronic means.

The service 24 then informs the server that the card has been sold, and indicates the amount. The server 16 sends the funds collected for each card, less a service charge, to the designated charities 26, 28, or once the value is retrieved from the gift card/certificate, whether sold on an outside site or by being retrieved from the gift card/certificate by other means, the value is sent automatically to the charity chosen to receive the donation, minus a service charge. As previously indicated, if the donor so prefers, his name is not released to the charities so that the charities cannot approach the donor at a later date for more donations keeping the donor anonymous.

The server or charity receiving the donation then may or may not send a letter to the donor indicating the face amount of the card as a donation for tax purposes, or any other purpose.

As discussed above, gift cards are readily available from a large number of sources, such as many retailers. Some cards are available only from the retailers themselves, while other gift cards are available at virtually any type of retail outlets. In another embodiment of the invention, the system 10 is used as a means of distributing donor cards from different charitable organizations. These donor cards are imprinted with the name of the charitable organization, and, optionally, a message about the services or causes associated with the organization. The donor cards are sold in any denominations, at any charitable function as well as at retail outlets. The vendor collects funds from donors for the cards, and sends the funds to the system 10 or directly to the charitable fund. The donor receives the card and, uses the card as proof of donation for tax purposes, or optionally, receives a statement from the vendor for tax purposes. However, the donor is shielded from the charitable organization.

The foregoing discussion is included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

I claim:

1. A system for converting unused gift cards into donations to charities comprising:
a server managing requests for converting a gift card and issuing an identification for said requests;
a collection station receiving a gift card from a donor and associating said gift card with a corresponding request; and
a resale server that sells the collected gift cards and obtains corresponding funds;
wherein said server transfers at least a portion of said funds to at least one preselected charity.

2. The system of claim 1 wherein said server is connected a donor database collecting information about donors of gift cards and associating each donor with a corresponding gift card.

3. The system of claim 1 wherein said server is connected to a charity database collecting information about charities accepting donations from funds obtained from sold gift cards.

4. The system of claim 1 wherein said server is adapted to provide a receipt to each donor indicating the funds collected for the respective donated gift card.

5. The system of claim 1 wherein said resale server performs an auction for selling donor cards.

6. The system of claim 1 wherein said request includes information identifying at least one of a donor name, gift card identification, gift card face value and gift card expiration date.

7. A method of converting unused gift cards into donations comprising:
receiving an unused gift card from a donor by a server;
selling the received gift card and collecting funds in return;
donating at least a portion of said funds to a charity; and
issuing a receipt to the donor.

8. The method of claim 7 further comprising receiving a request for donating said gift card by the server; assigning an identification associating each donor with a respective gift card; obtaining said gift card and identifying the gift card based on said identification.

9. The method of claim 7 further comprising providing a list of available charities to the donor and receiving a selection of at least one charity from the donor as a designated charity to receive said funds.

10. The method of claim 7 wherein said step of selling includes auctioning the donated gift card.

11. The method of claim 7 wherein said server runs a website, and wherein said donor provides information regarding a donation on said website.

12. The method of claim 7 wherein said step of converting donated gift cards into funds is performed automatically using a dedicated selling server.
